(19) United States
(12) Patent Application Publication
(10) Pub. No.: US 2014/0195246 A1
(43) Pub. Date: Jul. 10, 2014

(54) MIRROR WITH AUDIO-EMITTING DEVICE

(71) Applicant: Gwendolyn Maynor, Port Washington, MD (US)

(72) Inventor: Gwendolyn Maynor, Port Washington, MD (US)

(21) Appl. No.: 13/736,923

(22) Filed: Jan. 8, 2013

(51) Int. Cl. G10L 21/00

(52) U.S. Cl. CPC G10L 21/00
USPC 704/275

(57) ABSTRACT

A mirror has an audio-emitting device. A pre-recorded message plays aloud through a speaker on the frame of the mirror. The mirror has a voice or sound recognition actuation means. The message is preferable one of positive encouragement, and the preferred embodiment is for use as a therapeutic tool for treating individuals with low self-esteem or depression.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to mirrors, and more specifically to a personal vanity mirror frame having a sound device, for recording a positive message and improving the user's self-esteem.

2. Description of the Related Art

Audio-emitting devices are common in novelty items, and lately, new technology for smaller devices has allowed for such audio-emitting devices in greeting cards. Recording devices found in various electronic items readily available on the market such as mini-tape recorders and in cellular telephones. The recording devices have a reply function for the message recorded by a user.

The present invention provides the desired combination of a mirror sized for personal use, such as a vanity mirror, and enables a user to record a personalized message on an audio recording device within the frame for the mirror.

### BRIEF SUMMARY OF THE INVENTION

The invention is a mirror combined with an audio-emitting device.

### BRIEF DESCRIPTION OF THE SEVERAL VIEWS OF THE DRAWINGS

FIG. 1 is a front view of the mirror.

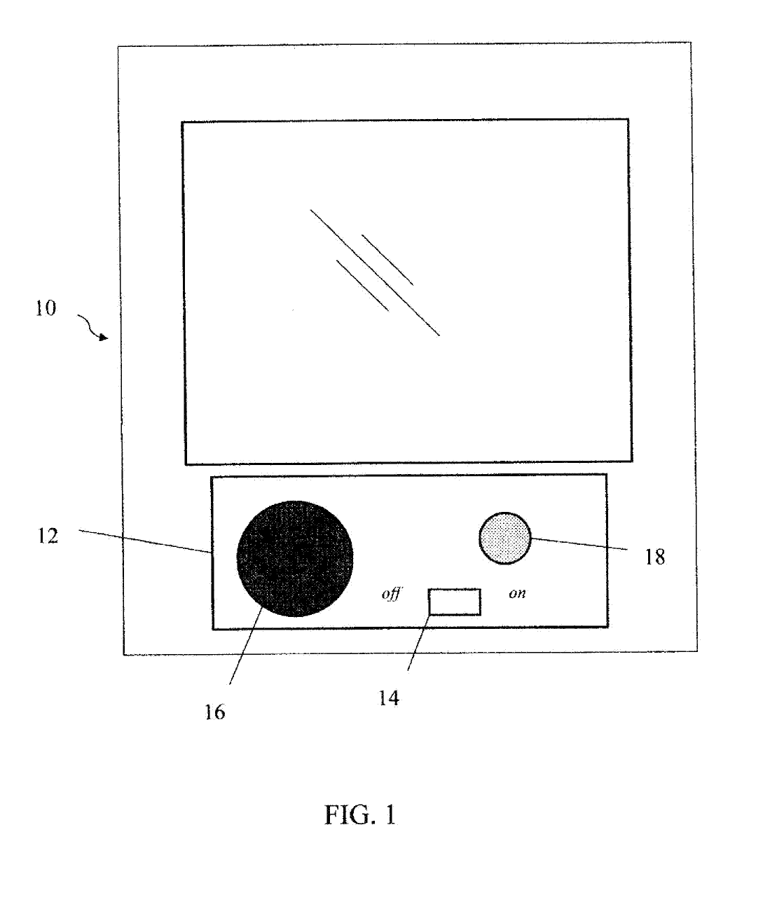

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

The invention is a mirror 10 with a recording and playback apparatus 12 connected to the mirror 10. A user of the invention looks at her reflection in the mirror 10 and activates the audio-emitting device in order to hear a pre-recorded message or song. The mirror 10 has a first activation means, which can be voice-specific or sound-specific.

The pre-recorded message plays through at least one broadcasting means, such as a speaker 16. The volume is controlled through a variable sound controlling means, such as a volume dial. 18. The message is typically one of a encouragement and positive compliment to the user in order to enhance self-esteem.

In the preferred embodiment, the audio-emitting device is substantially circular or oval-shaped. The user must actuates the device in order to emit the sound, which is intended to be a pre-determined recording such as song lyrics or spoken words. The audio-emitting device may be removable from the respective invention so that the various devices are interchangeable. The audio-emitting device may be any of those standard devices in the industry, such as those utilized in novelty greeting cards and interactive holiday display decorations, which require a user to perform a task such as opening the card or pressing a button to cause the sound to be emitted. In an alternative embodiment, a device may also contain a USB port for uploading a desired sound form a web-based system and database. Finally, in still another embodiment, a device may also have recording capabilities, for the purpose of hearing a personalized message.

An instructive pre-recorded message would play for the user, such as a message to remind of appointments, or medication schedules. The user actuates the playback feature in order to hear the pre-recorded message played aloud. More than one message may be recorded. The preferred embodiment for the invention is for use by individuals with low self-esteem. The invention serves a role to improve self-image and as a therapeutic tool for depression. The invention provides a pre-recorded message of encouragement and reassurance, in order to help the user cope with everyday issues related to depression.

While certain preferred embodiments of the present invention have been disclosed in detail, it is to be understood that various modifications may be adopted without departing from the spirit of the invention or scope of the following claims.

1. A mirror in combination with speakers and an audio-emitting device, comprising:
A means to actuate said device for recording, and playing a sound, wherein said sound is a statement of positive self-esteem, and the means to actuate said device is a voice-recognition signal.
